(19) United States
(12) Patent Application Publication
(10) Pub. No.: US 2014/0289260 A1
(43) Pub. Date: Sep. 25, 2014

(54) Keyword Determination

(71) Applicant: HEWLETT-PACKARD DEVELOPMENT COMPANY, L.P., (US)

(72) Inventors: Steven J. Simske, Fort Collins, CO (US); Malgorzata M. Sturgill, Fort Collins, CO (US); Marie Vans, Fort Collins, CO (US)

(73) Assignee: HEWLETT-PACKARD DEVELOPMENT COMPANY, L.P., Houston, TX (US)

(21) Appl. No.: 13/848,768

(22) Filed: Mar. 22, 2013

(51) Int. Cl. G06F 17/30

(52) U.S. Cl. CPC G06F 17/30424
USPC 707/748; 707/758

(57) ABSTRACT

Examples disclosed herein relate to keyword determination. In one implementation, a processor determines a summary of a text and identifies a keyword related to the text based on a comparison of the summary of the text to the remaining portion of the text. The processor may output the identified keyword.

### BACKGROUND

Searches may be performed based on keywords. For example, documents may each have a set of keywords associated with them that indicate information about the topic of the document. A query may include a set of words, and a search may be performed to search for documents with the same keywords as the query.

### BRIEF DESCRIPTION OF THE DRAWINGS

The drawings describe example embodiments. The following detailed description references the drawings, wherein:

FIG. 1 is a block diagram illustrating one example of an apparatus to determine keywords to associate with a text.

FIG. 2 is a flow chart illustrating one example of a method to determine keywords to associate with a text.

FIG. 3 is a block diagram illustrating one example of associating keywords with a text.

FIG. 4 is a flow chart illustrating one example of determining a summary to use to associate keywords with a text.

### DETAILED DESCRIPTION

In one implementation, keywords may be automatically identified in a text based on a comparison of the words in salient portions of the text to words in non-salient portions of the text. Using a comparison of salient portions of the text to non-salient portions and/or words in salient and non-salient portions of the text may result in a more effective method for automatically determining keywords. For example, a keyword indicating a topic of the text may be more frequently found in the salient portions of the text than in the non-salient portions of the text. Prepositions and other common words may be found nearly equally in both portions, and words that are found more frequently in non-salient portions may not be indicative of an important keyword despite a high frequency in the text as a whole.

As an example, a ratio may be determined for each word in the salient portion where the ratio compares the frequency of the word in the salient section compared to the frequency of the word throughout the text including both salient and non-salient sections. Words with higher ratio values may be automatically determined to be keywords. The salient portion may be smaller, and in some cases much smaller, than the non-salient portion. As such, the salient portion may be unlikely to have a high relative content of non-crucial text. In addition, it may be unlikely that non-crucial text occurring in the salient portion would not also occur in the non-salient portion. The ratio of the frequency between a word in the salient versus non-salient portions may take advantage of these assumptions.

Associating keywords with text may be useful for indexing and searching the text. The keywords may be used, for example, by Internet search engines. It is desirable to have an effective automatic method for associating keywords to documents to facilitate document searching. Keywords may also be useful, for example, for workflow selection.

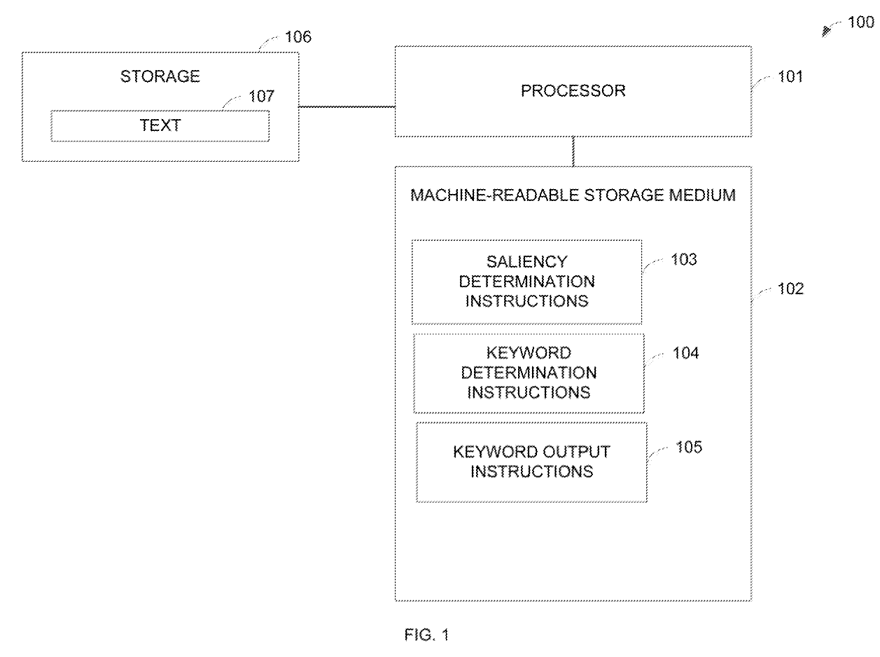

FIG. 1 is a block diagram illustrating one example of a computing system 100 to determine keywords to associate with a text. The computing system 100 may automatically determine a keyword to associate with the text based on a comparison of the words in the salient portions of the text to the words in the non-salient portions of the text. For example, words more important to the content of the document may occur more frequently in salient portions of the text.

The computing system 100 may include a storage 106, a processor 101, and a machine-readable storage medium 102. The computing system 100 may be part of a standalone computing device, and/or the components may communicate via a network. For example, the processor 101 may communicate with the storage 106 via a network.

The storage 106 may be any suitable storage in communication with the processor 101. The storage 106 may include text 107. The text 107 may be, for example, a document, a webpage, social informational media (such as wikis), or other textual compilation of information. The text 107 may include additional non-textual information, such as images and associated metadata. The content of the text 107 may be related to a particular topic or set of topics.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include saliency determination instructions 103, keyword determination instructions 104, and keyword output instructions 105.

The saliency determination instructions 103 may include instructions to determine salient portions of the text 107. The salient portions of the text 107 may be more indicative of the overall content of the text 107 than the remaining portions of the text 107. In one implementation, the processor accesses a particular portion of the text 107, such as an abstract, title, introduction, or conclusion, and categorizes it as the salient portion. In some implementations, relative saliency is determined. For example, different weights may be associated with different saliency levels, such as where a title and abstract are both categorized as salient, but a title is given greater saliency weight.

In one implementation, a summarizer engine is run on the text 107 to automatically determine the salient portions of the text 107. In some cases, the processor may combine the output from multiple summarizer engines to determine the salient portion of the text. For example, the processor may analyze the output from multiple summarizer engines and combine them in a prioritized manner based on a weight associated with each of the summarizer engines.

The keyword determination instructions 104 include instructions to determine words within the text 107 that are keywords based on the determined salient portions of the text 107 compared to the determined non-salient portions of the text 107. In one implementation, the keyword determination instructions 104 include instructions to determine the frequency of each word in the salient portion and to compare the salient portion frequency to the frequency of the respective word in non-salient portions and/or to compare the frequency of the respective word in salient and non-salient portions combined.

Other rules may also be applied. For example, a word frequency over a threshold in the salient portion may be identified as a potential keyword. In one implementation, a method is adopted to prevent overweighting of spare words in cases where the summary and non-summary portions are relatively short. For example, a non-integer value, such as 0.1, may be assigned to text occurrences when integer number of occurrences is actually 0.

The ratios may be compared such that the words with higher ratios are categorized as keywords. For example, words with the top 5 ratios, the top 1% of ratios, or ratios above a threshold may be categorized as keywords.

The processor may determine any number of keywords to associate with the text 107. In some implementations, a uniform number may be determined for each text evaluated, and in some implementations different texts may have different numbers of keywords.

The keyword output instructions 105 include instructions to output the determined keywords. For example, the processor may display, store, or transmit the keywords. The processor may store the keywords such that they are associated with the particular text 107. In some cases, the processor may receive a user query and search for texts with keywords corresponding to the user query.

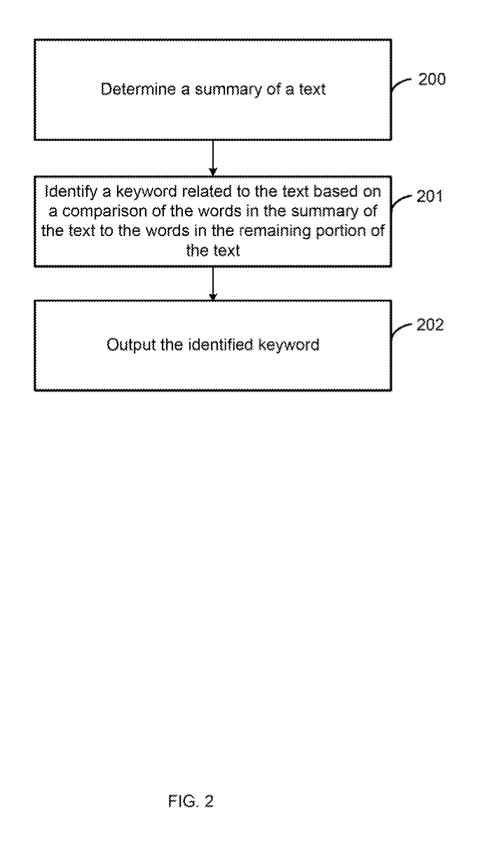

FIG. 2 is a flow chart illustrating one example of a method to determine a keyword associated with a text. For example, the importance level of words may be determined based on their frequency in salient portions of the text as compared to other portions of the text. A word occurring more frequently in salient portions as opposed to the text as a whole may be indicative of a higher importance level. Words with a higher importance level, such as above a threshold, may be identified as keywords for the text. The method may be implemented, for example, by the processor 101.

Beginning at 200, a processor determines a summary of a text. The text may be, for example, a document, log file, or webpage. The summary may be any smaller amount of text representative of the text and/or representative of a portion of the text. The processor may determine the summary in any suitable manner. In one implementation, the process accesses a precompiled summary of the text, such as an abstract or other summarization. The summary may be separate from the remaining text or may include particular parts of the remaining text as the summary. The summary may be based on information in addition to text. For example, the summary may be based on metadata, words found in images, or titles of documents.

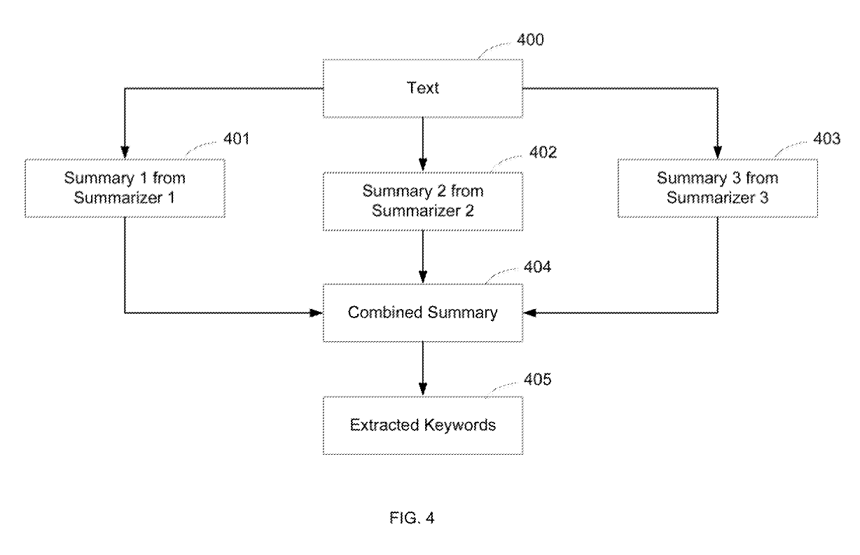

In one implementation, the processor automatically determines a summarization of the text based on an analysis of its contents. For example, the processor may apply a summarization method to the text. In one implementation, the processor receives summaries from multiple summarization engines and combines the summaries to form a single summarization for the text. An example of combining the output from multiple summarization engines is provided in FIG. 4. Combining multiple summarization engines to receive a higher quality summary in addition to comparing the summary text to the non-summary text may result in a more effective method for determining keywords to associate with a text.

Continuing to 201, a processor identifies a keyword related to the text based on a comparison of the words of the summary of the text to the words of the remaining portion of the text. The identified keyword may be, for example, a word likely to be of high importance in the text, such as indicative of the topic of the text.

In some implementations, the processor may perform some preprocessing on one or both sets of texts prior to comparing the words in the text. The processing may prevent slight variations of words from being determined to be dissimilar. For example, the processing may include lemmatizing the words in the text, stemming the words in the text, associating the words in the text with synonyms, translating the words in the text, tokenizing the words in the text, weighting portions of the text, and associating pronouns in the text with proper names.

The processor may compare the summary text to the remaining portion in any suitable manner. In one implementation, the processor determines a list of words occurring in the summary and their frequency and a list of words in the remaining portion and their frequency. The processor may determine a ratio indicating the frequency in the sections, such as (frequency in summary)/(frequency in entire text) or (frequency in summary)/(frequency in remaining portion). The ratio may be normalized to account for different sizes in the summary and the remaining portion of the text. For example, the ratio may be the frequency of the word in the summary divided by the number of the words in the summary compared to the frequency of the word in the remaining text compared to the number of words in the remaining text. Comparing the two sections of the text may prevent words common throughout, such as words usually categorized as stop words, from being assigned as keywords due to a similar patter through the summary and remaining text. The higher the determined ratio, the higher the importance level of the term in the text.

A keyword may be determined based on a comparison of the ratios of the different terms. For example, the top n ratios, the top n % of the ratios, or ratios greater than x may be determined to be associated with keywords. Additional rules may also be applied. For example, words that do not appear in the summary may be thrown out as not keywords because the ratio would be zero. As another example, a threshold rule may be used that a keyword appears in the summary at least x times or x times per word in the summary. In one implementation, multiple levels of saliency are determined, and different ratios are determined for the different levels of saliency. For example, a title may be considered to be more salient than a summary, and a ratio for a word appearing in the title may be weighted to reflect the greater importance.

Proceeding to 202, a processor outputs the identified keyword, For example, the processor may display, transmit, or store the keyword. In one implementation, the processor stores the set of keywords associated with the text. The keywords may be used for indexing the text. The keywords may be determined for different sections of the text. For example, a different set of keywords may be associated with each chapter of a book such that different sections may be searched based on the different keywords. In one implementation, the summary and keywords are displayed on a user interface that allows for a user to provide user feedback on the automatic keyword determination.

In some cases, the same processor or a different processor may search the text based on the associated keywords. For example, a query may include a list of keywords and the processor may search for documents with the same or similar set of keywords. The automated process of creating keywords may prevent and/or improve manual tagging and result in high quality searching in an automated manner.

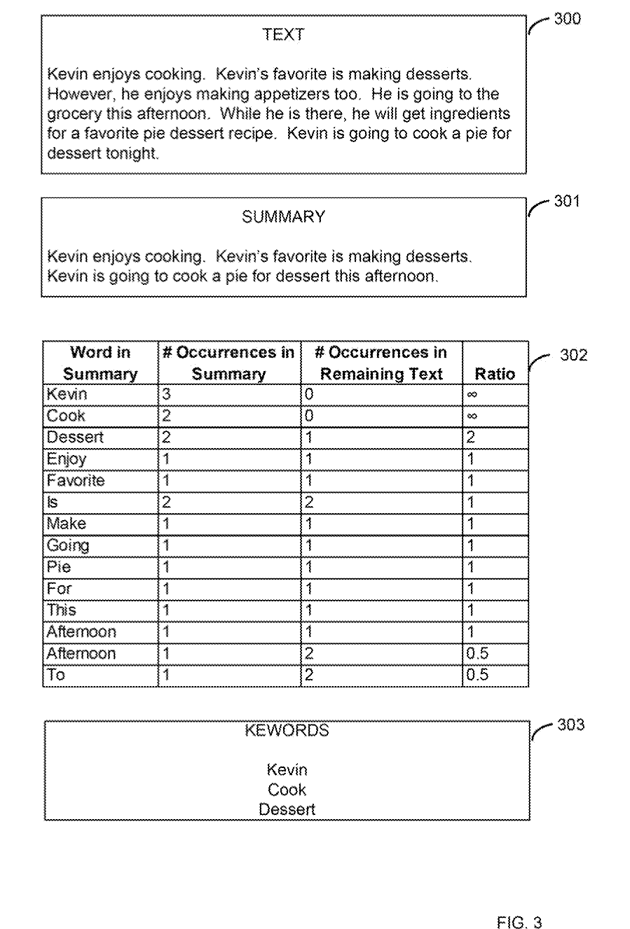

FIG. 3 is a block diagram illustrating one example of determining a keyword to associate with a text. Block 300 shows a sample text. The text includes six sentences about Kevin's cooking. Block 301 includes a summary of the text in block 300. The summary includes three of the six sentences from block 300 as being salient portions of the text. For example, the first, second, and sixth sentences are included in the summary. The summary may be accessed from a storage or may be automatically determined. In some cases the summary may be determined both automatically and with the input of user feedback.

Block 302 shows one example of a table for comparing the relative importance of words in the text. The table includes each of the words from the summary in block 301 after some preprocessing has been performed. The frequency of each of the words in the summary is shown (frequency in sentences one, two, and six), and the frequency of each of the words of the remaining text is shown (frequency in sentences three, four, and five). A ratio of the number of occurrences in the summary compared to the number of occurrences in the remaining text is shown in the last column in decreasing order. The words with a higher ratio may be more representative of the overall concept text shown in block 300.

Block 303 shows keywords determined based on the table in block 302. For example, the words with the top three ratios may be determined to be keywords. The words “Kevin”, “cook”, and “dessert” are determined to be keywords and may be associated with the text in block 300 to allow it to be more easily searched.

FIG. 4 is a flow chart illustrating one example of determining a summary to use to associate keywords with a text. A summary may be automatically determined based on a prioritized combination of output from multiple summarization engines. Comparing a summary to a non-summary portion may be more effective where the summary is more representative of the content of the text.

Block 400 shows a text 400. Blocks 401-403 show the text with three separate versions of a summary of the text where each of the summaries is created by a different summarizer engine. The summaries are combined into a single summary in block 404. The summaries may be combined in a manner that prioritizes the output from the summarizer 1, summarizer 2, and summarizer 3. The prioritization may be based on a priority related to the particular summarizer and/or related to the output of the summarizer, such as where a sentence ranked as most important by the summarizer is prioritized over a sentence ranked as second most important by another summarizer. As an example, the summaries may be combined using a weighted voting method as described in PCT Application PCT/US2012/059917, herein incorporated by reference. Block 405 shows keywords extracted from the combined summary. For example, the method of FIG. 2 may be applied to the summary determined from the output of the three summarizers. Analyzing the content of a summary as compared to the content of the remaining text and/or the content of the non-summary portions of the text may result in a more effective method for automatically determining the importance level of words in a text to be used to determine keywords for indexing and searching the text.

1. An apparatus, comprising:
a storage to store a text; and
a processor to:
determine salient sections of the text and non-salient sections of the text;
determine a list of keywords related to the text based on a comparison of the frequency of words in the salient sections to the frequency of words in the non-salient sections; and
output the determined list of keywords.

2. The apparatus of claim 1, wherein determining a salient section of the text comprises determining a summary based on a combination of the output from multiple summarizers.

3. The apparatus of claim 2, wherein combining the output from multiple summarizers comprises combining the output from the multiple summarizers in a prioritized manner based on a weighted voting method.

4. The apparatus of claim 1, wherein comparing the salient section to the non-salient section comprises:
determining a ratio of at least one of:
the number of times a word appears in the salient section to the number of times the word appears in the non-salient section; and
the number of times a word appears in the salient section to the number of times the word appears in the text; and
determining the list of keywords based on a comparison of the ratios.

5. The apparatus of claim 4, wherein determining the list of keywords comprises determining the list of keywords based on at least one of: the top n ratios, the top percentage of the ratios, and ratios greater than a threshold.

6. The apparatus of claim 1, wherein the processor is further to preprocess the text by performing at least one of: lemmatizing the words in the text, stemming the words in the text, associating the words in the text with synonyms, translating the words in the text, tokenizing the words in the text, weighting portions of the text, and associating pronouns in the text with proper names.

7. A method, comprising:
determining a summary of a text;
identifying, by a processor, a keyword related to the text based on a comparison of the words in the summary of the text to the words in the remaining portion of the text; and
outputting the identified keyword.

8. The method of claim 7, wherein comparing comprises determining a ratio of at least one of:
the frequency of a word in the summary compared to the frequency of the word in the remaining portion of the text; and
the frequency of a word in the summary compared to the frequency of the word in both the summary and remaining portion of the text.

9. The method of claim 8, further comprising normalizing the ratio based on at least one of the number of words in the summary and the number of words in the remaining text.

10. The method of claim 7, wherein determining the summary of the text comprises determining the summary of the text based on a combination of the output from multiple summarizers.

11. The method of claim 8, wherein determining the summary of the text based on a combination of output from multiple summarizers comprises applying a weighted voting method between multiple summarizers.

12. A machine-readable non-transitory storage medium comprising instructions executable by a processor to:
determine an importance of a word in a text based on the comparison of the frequency of a word in a salient version of the text to the frequency of the word in a non-salient version of the text; and
determine whether to categorize the word as a keyword based on the determined importance level relative to the importance level of other words in the text.

13. The machine-readable non-transitory storage medium of claim 12, further comprising instructions to determine a salient version of the text based on a weighted combination of the output of multiple text summarization methods.

14. The machine-readable non-transitory storage medium of claim 12, wherein the comparison comprises the frequency of the word in the salient version compared to the frequency of the word in both the salient and non-salient version.

15. The machine-readable non-transitory storage medium of claim 12, further comprising instructions to perform at least one of searching and indexing the text based on the list of keywords.
